(19) United States
(12) Patent Application Publication
(10) Pub. No.: US 2017/0018197 A1
(43) Pub. Date: Jan. 19, 2017

(54) PLANNING, COMMUNICATION AND MANAGEMENT SYSTEM FOR STRUCTURING AND ORGANIZING INFORMATION AS WELL AS SUPPORTING CREATIVE MODELING PROCESSES WITH PHYSICAL ELEMENTS

(71) Applicant: R3 COMPANIES GMBH, Zurich (CH)

(72) Inventors: Moritz MUSSGNUG, Zurich (CH); Stefan BOËS, Zurich (CH); Bastian LEUTENECKER, Zurich (CH); Dominick NOLI, Zurich (CH); Mirko MEBOLDT, Zurich (CH)

(21) Appl. No.: 15/212,013

(22) Filed: Jul. 15, 2016

Related U.S. Application Data
(63) Continuation of application No. PCT/EP2014/050741, filed on Jan. 5, 2014.

(51) Int. Cl. G09B 1/08

(52) U.S. Cl. CPC G09B 1/08

(57) ABSTRACT

A system for creating thought models having a plurality of elements (1, 2, 3) movable over a magnetic or magnetizable platform (2). The elements are differently geometric shaped and colored to characterize a piece of information. Each piece also has a writing surface. The invention further relates to methods for organizing, arranging, communicating and/or visualizing and/or displaying of information.

### CROSS-REFERENCE TO RELATED APPLICATIONS

The present application is a continuation of and claims priority under 35 U.S.C. §120 and §365(c) to PCT International Patent Application PCT/EP2014/050741, filed Jan. 15, 2014, and is incorporated herein by reference in its entireties.

### BACKGROUND OF THE INVENTION

The present invention provides a novel system for organizing, arranging, communicating, inter-acting with and/or visualizing and/or displaying of information having a plurality of elements to be magnetically secured to a platform.

In particular, this invention relates to systems for assistance in decision making and for creating useful models of systems and procedures. Essentially, it is concerned with establishing a proper association between ideas and concepts in the context of education, business and other practices. In its broadest sense then, the invention is directed to systems for creating and structuring thought models.

The main aspect of working in groups is the interaction between the participants and the content, represented in analog or digital form. Both analog and digital content have their disadvantages concerning interactivity. On the one hand, analog is usually missing flexibility in form of shiftable elements that can be repositioned on the analog platform, but also the transfer from individual work at the table to collaborative work on the analog platform is not supported. On the other hand, digital usually implies less tangibility, restriction of creative freedom for visualization and barriers for every person's involvement by allowing only one person to input information and interact with the content at one time. For a widely spread use and a low entry threshold, such a tool would have to be available at low costs and to be compatible to existing systems.

Thus, there is a need for a system and methods which help to increase the interactivity in group work and presenting and structuring pieces of information.

### SUMMARY OF THE INVENTION

The present invention is conceived to solve these drawbacks as described above, by providing the embodiments characterized in the claims.

This present invention provides for the first time a working appliance as well as a new concept for working together in teams, which supports the interactivity and reduces barriers from typical analogue and digital working styles. This invention allows working on content collaboratively, to synthesize prior individual work together on the analog platform and they fulfill the need for a dynamically evolving model on the analog platform.

In particular, the present application relates to a system for assistance in creating shiftable and/or repositionable elements which can be repositioned by magnetic means on a platform suitable for project-based interaction. This invention also relates to the use of the system in processes of structuring and creating concepts for presentations, diagramming and modeling software as well as planning processes and projects. The invention further relates to methods for organizing, arranging and/or displaying of information and thus by increasing the interactivity in a group of people.

In particular, the present invention provides a novel system for organizing, arranging, communicating, interacting with and/or visualizing information having a plurality of elements to be secured to a platform, characterized in that each element is repositionable and/or shiftable, having a modulus of elasticity (E-module) of 0.05, 0.10, 0.15, 0.20, 0.25, 0.30, 0.35, 0.40, 0.45, 0.50, 0.55, 0.6, 0.65, 0.7, 0.75, 0.8 0.85, 0.9, 0.95, 1.05, 1.10, 1.15, 1.20, 1.25, 1.30, 1.35, 1.40, 1.45 and/or 1.50, preferably >0.5 kN/mm² and wherein the element has a material thickness of 0.1 to 30 mm.

A plurality of elements is accordance with the present invention is defined as at least 2, 3, 4, 5, 6, 7, 8, 9, 10, 11, 12, 13, 14, 15, 16, 17, 18, 19, 20, 30, 40, 50, 60, 70, 80, 90 and/or 100.

Each element also has a writing surface, enabling the user to specify a thought, a notice or a chart thereon. Also further notices such as paper Post-It® can be additionally used in accordance with the present invention and can be placed onto the elements. By that the cards can be labeled with any suitable marker or pen and the labeling can be very quickly and very thoroughly removed without leaving any remains which is necessary for fast cleaning and reusing the cards several times.

The inventors have surprisingly found out that the elements have to be specifically designed in order to be handy and intuitively used during a discussion or creative process without the need to focus on the labeling since the cards can be labeled on the go. Therefore, the elements must exhibit certain physical properties as further defined below, such as a certain size, thickness and/or stiffness. Otherwise writing onto the elements become time consuming or needs more attention which will disrupt the creative process.

These elements are mountable by magnetic force to a platform and thus become a mini platform itself. Preferably the elements are magnetically and/or magnetizable. In a preferred embodiment, the platform can be an analogue platform or a digital platform. An analogue platform can be any magnetic or magnetizable surface such as whiteboard, a flipchart, a blackboard, a desk, a table, a refrigerator door or any horizontal and/or vertical other flat suitable ferromagnetic and metallic board. As a skilled person will appreciate the present invention is not restricted to magnetic means, also other suitable measures wherein at least one element, and/or a plurality of elements and/or the receptacle can be placed onto a surface. Thus, an analogue platform surface in accordance with the present invention can also be any other surface, wherein elements can be secured by any known mounting brackets such as glue, plastic suction pad, mounting bracket, nails, etc. A skilled person is well aware of further suitable means which are also encompassed by the present invention.

A digital platform can be an analogue platform surface as defined above and further configured with digital means which allows transferring the information of the position of the elements on the platform as well as the information placed on the elements into a digital data set for further use. The skilled person is well aware of any suitable means how to convert analogue information into digital information. For example, a thin electronic foil can be laminated onto the elements and/or the platform which foil is capable of recognizing and translating the written signs and/or the position of the elements placed onto the platform surface into digital data sets. Another option would be that the pen can record the written signs or words and subsequently the stored data can be transferred to a computer for storage or further processing.

The elements according to the present invention essentially consists of a geometric form such as a circle, square, rectangle, triangle, oval, hexagonal or any other suitable form. In a preferred embodiment according to the invention, the plurality of the elements consists of squares and/or rectangle and/or circles, see also FIG. 1. Thereby, each of the elements can also be expressed in the ratio between length and width, which can be 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, and/or 30:1 In accordance with the present invention, a skilled person is well aware that the above mentioned ratios also applies vice versa, i.e. each of the elements can also be expressed in the ratio between width and length, which can be 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, and/or 30:1. Put in other words, in a preferred embodiment, the ratio between length and width of the element is 1:1 to 20:1. The elements are normally shaped such that they can nest neatly with adjacent elements on the platform to form blocks or groups which define a substantially solid surface.

Furthermore, the elements of the present invention have a front and a back surface. At least one, preferably both surfaces of the element is rewritable and/or erasable. Yet in a further preferred embodiment according to the present invention the element has roughness or surface quality of Rₐ 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.2, 5.3, 5.4, 5.6, 5.7, 5.8, 5.9, 6.0, 6.1, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 8.0, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, most preferably 0.1<10 μm. Thereby, an excellent smooth surface is provided, wherein even after years of use no resins are visible and these surfaces are easy to clean and maintain. It is common practice to use a single number (a “Rₐ” number) to characterize surface roughness.

In a further preferred embodiment of the present invention, the element has a mass per unit area that exceeds 150 g/m². Preferably the maximum mass per unit area is 20000 g/m². As a skilled person will appreciate the maximum weight is defined by the magnetic force, the size of the elements as well as depending on the needs of the person. Sometimes it is desired to have a light set of elements for carrying around, which is not important when the system is merely used stationary. For example, an element having a 10 cm width and a 10 cm length, being 1/100 m² can exhibit a weight of 100 g which corresponds to 10000 g/m².

In a further preferred embodiment of the present invention, the element has a material thickness of 0.1, 0.2, 0.3, 0.4, 0.5, 0.6, 0.7, 0.8, 0.9, 1.0, 1.1, 1.2, 1.3, 1.4, 1.5, 16, 1.7, 1.8, 1.9, 2.0, 2.1, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.7, 12.8, 12.9 13.0, 13.1, 13.2, 13.3, 13.4, 13.5, 13.6, 13.7, 13.8, 13.9, 14.0, 14.1, 14.2, 14.2, 14.3, 14.4, 14.5, 14.6, 14.7, 14.8, 14.9, 15.0, 15.1, 15.2, 15.2, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.2, 19.3, 19.4, 19.5, 19.6, 19.7, 19.8, 19.9, 20.1, 202, 20.2, 20.3, 20.4, 20.5, 20.6, 20.6, 20.7, 20.8, 20.9, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50. Preferably, the element has a material thickness of 0.1 to 20 mm.

Another important feature of the claimed element is the retention force per weight, measured parallel to the platform surface it is placed on. In a further preferred embodiment according to the present invention, the element exhibit a retention force per weight that is higher than 0.0250 N/g. The maximum retention depends on the needs of the skilled person. In case an element should be tightly secured, such as during orally presenting talks open air, it might be desirable to ensure that the retention force is very high.

According to the present invention, the elements have a size of a DIN A3 letter, a card, a post it, a moderation card, preferably not exceeding the size of DIN A4 letter and/or function as a mini platform and/or a mini whiteboard. These geometrically shaped elements may have any size which is handy to write on and to be placed on a platform and termed in accordance with the present invention MindCard(s).

In a further preferred embodiment, the plurality of elements comprises, essentially consists of or consist of elements having a circular shape, having a diameter of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 68, 69 or 70 mm. In addition, a magnet and/or a magnetized area can be centrally embedded. This embodiment is also referred to as MindDot according to the invention and can be used to assign and score particular contents and ideas written on the MindCard and/or the platform. It is to be understood that any geometric shape as defined above as well as 3D dimension, such as a disc, tubular or bar is suitable to be used as a MindDot as long as its size is substantially smaller that the MindCards and/or used to mark, value and/or highlight a piece of information.

The element can be made of any suitable materials as long as they meet the above mentioned properties. However, preferred in accordance with the present invention, the element is made of a material selected from a group consisting of non-metallic, metallic, organic or inorganic or a combination thereof. In a preferred embodiment of the present invention, the element can be made of a thermo-plastic resin selected from the group consisting of vinyl, acryl, ABS, and polyethylene.

The movable element in system according to the invention is normally planar, enabling them to be readily moved around the platform after a thought has been specified on the writing surfaces thereof. The platform surface may be magnetized or a magnet itself, and each element include at least one component which is integrated into the element and attracted to the platform surface. Such a component will usually be disposed substantially peripherally or centrally embedded of the respective element. Preferably, the component is magnetic and/or a magnet or the component facilitates that the element is attracted to the platform surface by other suitable means as defined above.

The component may or may not be a magnet and can be shaped as stripe, bar, foil, small round, hexagonal or any other geometric shape and are well known to the skilled person. It either can be laminated, integrated or fixed by other means. In case of magnets, it can be desirable that one tubular magnet such as a stripe may be sufficient while smaller in size magnets may be arranged in pairs in each corner or in all four corners.

In order to provide the possibility to emphasize and/or judge on a certain piece of information written on the element, the magnetic component is stackable. This is facilitated in that the magnetic component is polarized. In a further preferred embodiment, the magnetic component is axial and/or radial polarized, preferably both.

Surprisingly, the inventors revealed that by embedding two magnetic components as illustrated in FIGS. 1A and B in such a way that the magnetic components forms extensions on the top back surface of the element, a space between the platform and the portion of the element carrying the magnetic components is formed. Placing the element onto the platform an inclination of 0.15% to 2% is achieved. As a result, the element can be easily removed/picked up from the platform since the space acts as a lever or cover plate. The above mentioned arrangement of the magnetic component is particularly suitable for the above defined MindCard. Thus, in a preferred embodiment of the present invention, the magnetic component forms a spacer between the platform and the top back side of the element. It is to be understood that any other arrangement of the magnetic component, see for example FIG. 4, is also encompassed from the present invention. As a skilled person will understand, the use of non-extended magnetic components integrated into or attached to any surface of the element is also suitable, however it is also possible to incorporate a small corresponding recess into at least one lateral surface of the element.

In order to facilitate a smooth and productive process of organizing, arranging and/or displaying of information, further materials such as pens, cards pins, MindDots can be stored in receptacles (22, −3, 6) by, for example magnetic means on the platform. Thus, the present invention also provides at least one receptacle which fits with most commercially available pen, wherein the cap is attracted to the platform through an absorption area by an embedded magnet.

Hence, in further aspect, the present invention relates to system comprising a receptacle formed for receiving a conventional pen therein, a magnet is embedded in a portion thereof to secure a portion of the receptacle to the platform, wherein the receptacle and the received pen are configured to be inclined in a range of 0° to 90° with respect to the platform surface.

Depending on the shape of the receptacle as well as the weight of the pen, the angle of the pen and receptacle or holding portion such as a cap may vary between 0° to 90°. The term “0°” angel indicates that the pen is all most parallel with the platform; however 1, 2, or 3° is still to be understood to be parallel in accordance with the present invention. As evident from FIG. 2 the receptacle exhibit a sloping edge contact portion (7′). This arrangement facilitates that a pen engaged with the receptacle can be can be placed at an angle of up to 45°.

As a skilled person know, depending on the magnetic force, the receptacle is also capable to hold a pen in an angle of 45° to 90° or even more, also depending on the shape of the receptacle.

In one embodiment, the portion of the receptacle which forms contact with the platform is formed in a curved shape and wherein the receptacle and the received pen are configured to be inclined in a range of 0° to 45° with respect to the platform.

Alternatively the portion of the receptacle which forms contact with the platform is formed in a flat shape and wherein the receptacle and the received pen are configured to be inclined in a range of 0° to 90° with respect to the platform.

Naturally the present invention extents to a kit for use in organizing, arranging and/or displaying of information, comprising the element of the present invention and/or the receptacle described above and optional a case for storing the same. Such moderation cases are in general known to the skilled person and may further comprise or consist of suitable tools.

In use of such a kit, a thought model can be created by grouping different aspects of a project with respective topics identified for consideration within each group. This facilitates discussion of the project as a whole and resolution of problems arising therein.

In a further aspect of the present invention, the elements can also be used for presenting orally. Thus, pre-written elements can be integrated in a lecture or talk instead of a power point presentation. This kind of presentation is in particular suitable for interactive teaching and/or workshops. Since the system is modular and allows the integration of novel or rewritten elements, it can quickly and efficiently adapted to new requirements of the participants.

The basis of the present invention is the concept of providing a visible or physical representation of ideas, practical considerations, influential factors, and ultimate aims for example, presenting them in a manner which enables them to be grouped and classified in order to assist the user in arranging such thoughts in a manner which will facilitate his or her consideration of various aspects of a problem. Furthermore, the system can be used for diverse working processes such as brainstorming, mind maps, project planning as well as converging working processes such as judging and selection of ideas, structuring of contents distributing of work packages. Thereby, the system can be used by one person or a group of people.

Hence, the kit, the system as well as the element of the present invention are particular useful for and/or in processes of structuring and creating concepts for presentation, model based and/or object based development and/or modeling software, modeling software and/or in UML diagramming, SysML diagramming. In another aspect, the present invention relates to the use of the kit, the system as well as the element of the present invention in and/or for planning processes and projects use for quality and/or lean management and/or process optimization, and/or planning processes according to BPMN notation.

The identification characterizing the pieces of information placed on the elements is preferably further supported by color, and most preferably by the entirety of the respective writing surfaces bearing a solid color. As skilled person will appreciate that also translucent and/or opaque are to be understood to be a color in accordance with the present invention. Preferred embodiments of the invention include sets of elements bearing different colors, and the different colors can then be used to associate the color with different types of thought. Essentially, the inventors of the present invention have found that cognitive processes are facilitated by using colors that correspond to different kinds of thought factors.

By color coding of pieces in systems according to the invention in this way, the consideration of differ aspects of a particular situation is facilitated, see also FIG. 5, wherein the elements are color coded (24, 25, 26).

When using a system according to the invention, an individual or group of individuals can present a series of thoughts or factors which are relevant in the consideration of a situation, and categorize and structure them according to type such as those listed above with reference to the proposed color coding, geometric shape of the elements or by writing onto the platform. Each piece of information such as a thought or a factor is then specified on an element bearing the appropriate identification, and placed on the platform. The elements can then be moved around the platform thereby relating each piece of information, thought or factor to a specific aspect of the situation or process. The MindDots can be placed onto certain MindCards in particular onto the magnet of the MindCards thereby highlighting and/or validating important aspects or a piece of information. As shown in FIG. 5, also the MindDot can have different colors such as green or red in order to give a positive (green) or a negative (red) signal.

The pieces of information having been so arranged on the platform, the model created can be considered as a whole or separately.

The benefit of the present invention is the analog structuring of pieces of information or thought, which will increase the interactivity between the people and furthermore due to the properties of the elements, they can be easily reorganized for fast and vividly demonstration and illustration. Furthermore, the processes can be quickly changed since the elements are rewritable, thus allowing editing the information placed onto MindCard without the need of using new elements. These are but some examples of the benefits that are available by grouping otherwise possibly random thoughts or factors in a manner which aid the reaching of some form of decision.

An embodiment of the invention will now be described by way of example and with reference to the accompanying drawing which illustrates an arrangement of elements on a substrate which represents a piece of information generated using a system according to the invention.

The inventors surprisingly revealed when using the system and the method of the present invention that the usage of the MindCard concept led to promising results. The students adapted fast and intuitively to the taught activities. In the sessions, the students were more involved and interacting actively with the content. This involvement led to a common understanding of the problem or the task. It resulted in shorter learn and iteration cycles. Additionally the students continued to use the concept, even after the teaching staff was not involved anymore and the use was optional.

### IN THE DRAWINGS

FIG. 1: depicts the front surface of three different geometrically shaped elements (1, 2, 3). In FIG. 1A a quadratic element (1) having a width of 99 mm and a length of 99 mm is depicted, wherein two magnets (3) having a diameter of 6 mm are embedded. In FIG. 1B rectangular element (2) also termed Mindcard in accordance with the present invention is illustrated having a height of 99 mm and a length of 198 mm, wherein two magnets (3) having a diameter of 6 mm are embedded in the corners of the element (2). The magnets can extend on the surface out of the elements (1, 2) (not shown) in order to form a space which can acts as a lever or cover plate, see for further explanations the description. A third circular element (4) is depicted, termed MindDot, having a diameter of 25 mm and a centrally arranged magnet (5) having a diameter of 6 mm and wherein the magnet also forms an extension as described above. All three elements are made of acrylic glass also known under the trademark Plexiglas® distributed by the company Evonik industries.

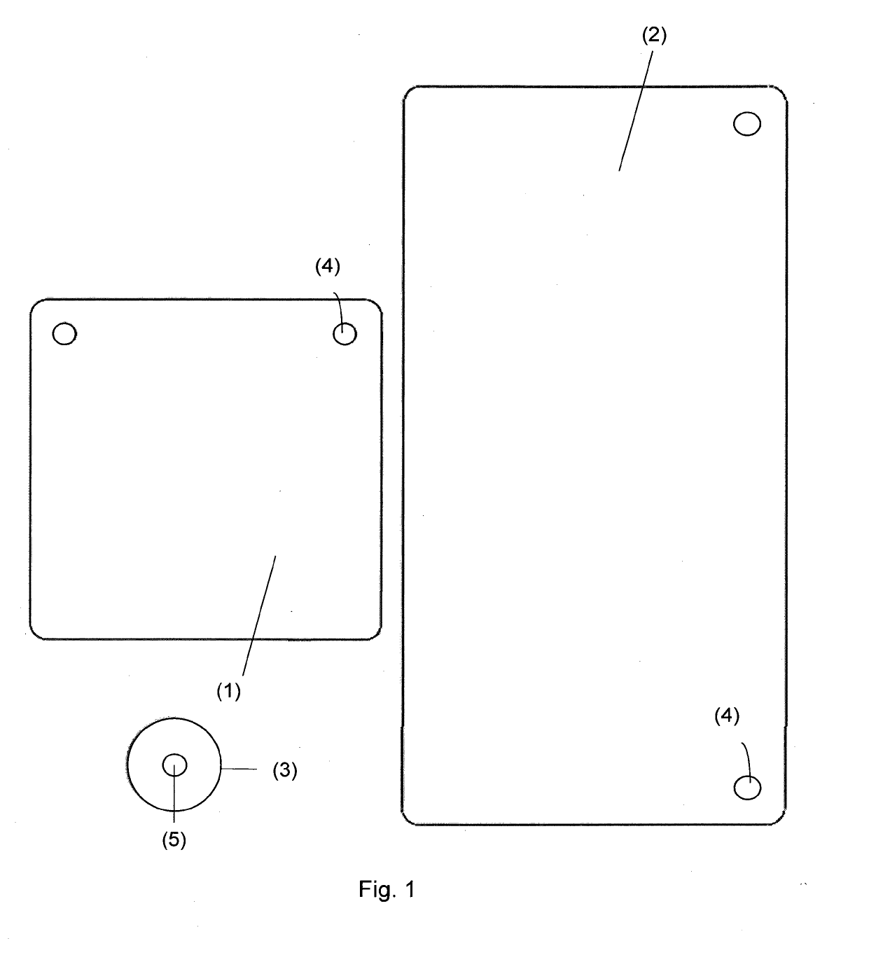

FIG. 2: is a perspective view of a cap body (6) in accordance with a preferred embodiment of the present invention. A. longitudinal and cross-section of a cap body (6) having a peripheral wall (7) which forms a cuboid-shaped hollow space, wherein a ball-shaped magnet (8) is mounted below the top part of the cap or lined onto the inner surface of the peripheral wall (7). The cap body can form contact with a ferromagnetic wall or magnetic surface at different angles such as 0°, 90° C. In order to form contact surface with the platform at an angle of 1° to 45°, the receptacle exhibit a sloping edge contact portion (7′). B. a perspective view of the cap (6).

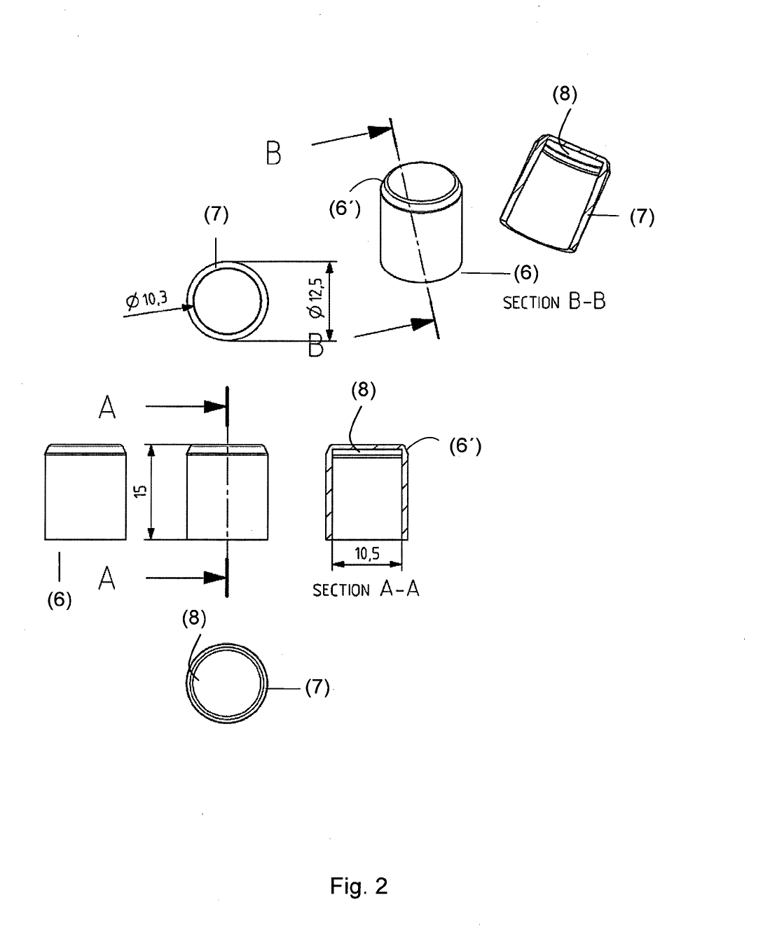

FIG. 3: shows an alternative embodiment of the cap (9) in a perspective view. The cap body (9) having a peripheral wall (10), wherein the inferior cylindrical bottom (11) exhibit a thicker wall thicknesses (12) than the dome-shaped superior part (13) of the cap body (9). The transition middle part (14) of the cap body (9) from a bottom-up direction is sloping at an angle of 103.86° and having a circular lip (15) on the inner surface at the beginning of the transition middle part (14), keeping the magnet in position. A ball-shaped magnet (16) is mounted underneath the dome-shaped superior part (10) of the cap body (6).

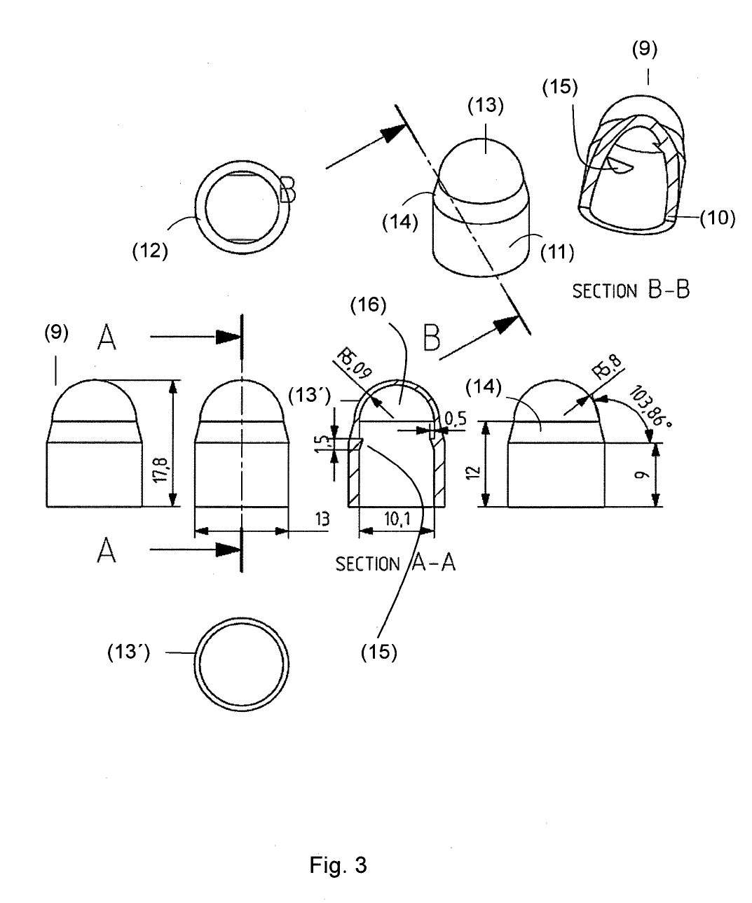

FIG. 4: A whiteboard (17) is shown, wherein various quadratic elements (1) are arranged and labeled (18) in order to organize different pieces of information into a certain hierarchy. Further pieces of information (19) are placed onto the whiteboard in order to structure the pieces of information written onto the elements (1). A MindDot (20) is stacked onto the magnet of an element (1) in order to highlight one piece of information. A pen engaged in the cap body (6) as illustrated in FIGS. 2 and 3 is stored onto the whiteboard and ready to use (21).

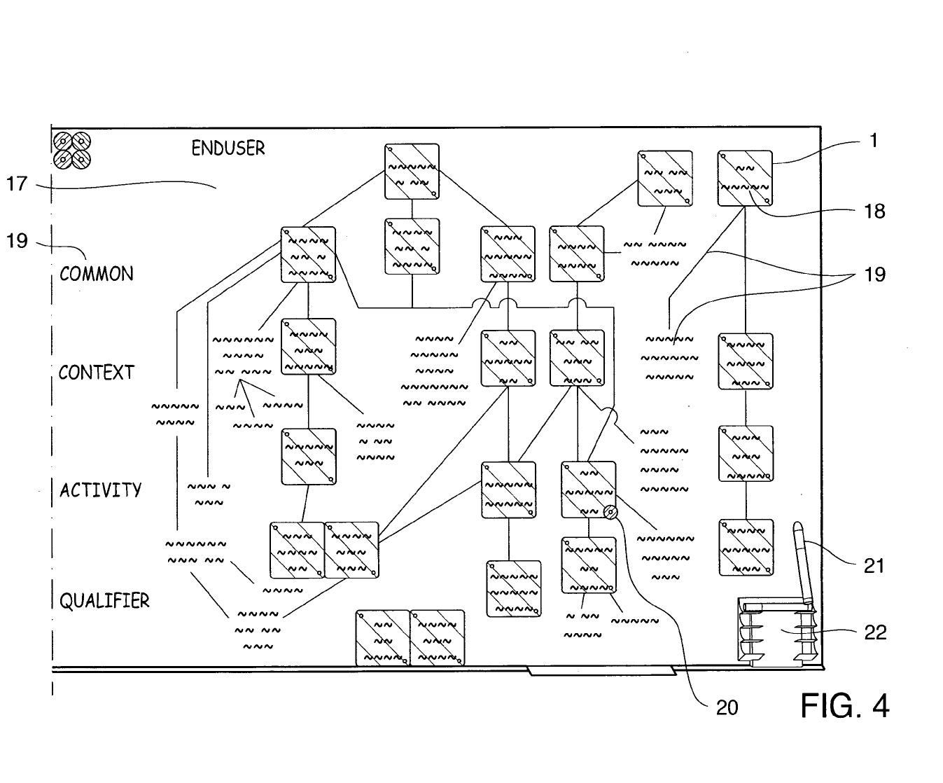

FIG. 5: depicts a setting, wherein a presentation is prepared and the different aspects and thoughts are placed onto differently shaped and differently colored elements (1, 2, 24, 25). Further structure is given by the notices (23) written onto the whiteboard (17). The MindDots (3) are used to put emphasizes on certain aspects written onto the quadratic MindCard (1). Note, that the two MindDots (26) exhibit different colors, namely red and green.

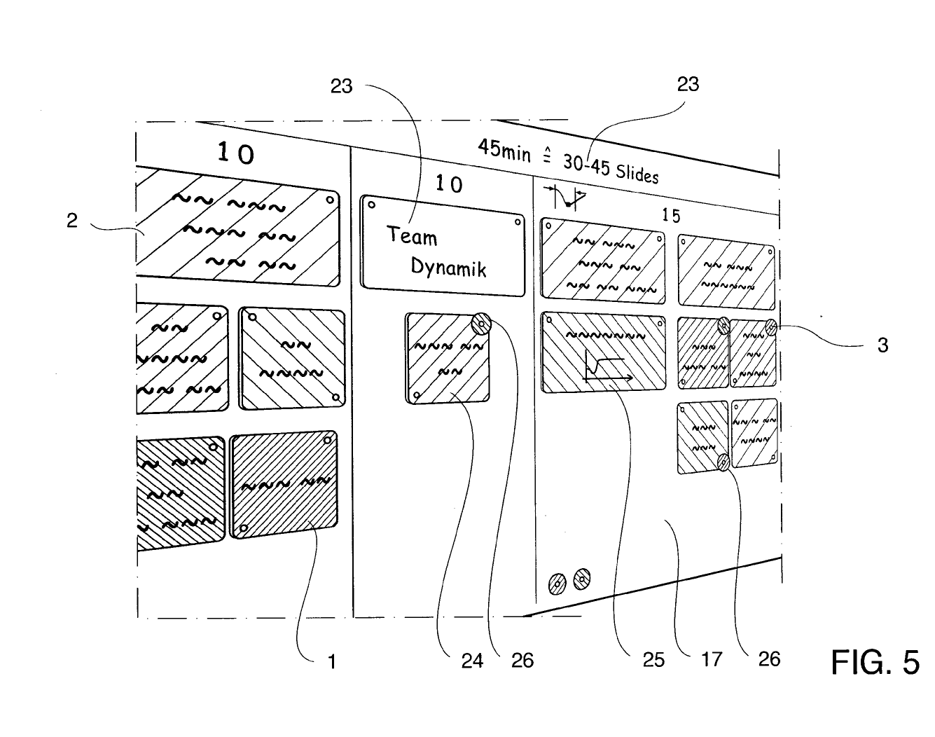

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

1. System for organizing, arranging, communicating, interacting with and/or visualizing information having a plurality of elements (1, 2, 3) configured to be secured to a platform surface (17), characterized in that each of the plurality of elements is repositionable and/or shiftable, and has a modulus of elasticity (E-module) of >0.5 kN/mm² and a material thickness of 0.1 to 30 mm, wherein the platform surface (17) is a magnetic or magnetizable device, and wherein each of the plurality of elements (1, 2, 3) is magnetically securable to the platform surface (17).

2. System according to claim 1, wherein the platform surface (17) is an analogue platform surface and/or a digital platform surface.

3. System according to claim 1, wherein each of the plurality of elements (1, 2, 3) has a mass per unit area that exceeds 150 g/m².

4. System according to claim 1, wherein a surface of each of the plurality of elements (1, 2, 3) is rewritable and/or erasable.

5. System according to claim 1, wherein each of the plurality of elements (1, 2, 3) has a surface quality (roughness) of Rₐ 0.01<10 μm.

6. System according to claim 1, wherein a ratio between length and width of each of the plurality of elements is 1:1 to 20:1.

7. System according to claim 1, wherein each of the plurality of elements (1, 2, 3) has a retention force of more than 0.025 N/g.

8. System according claim 1, wherein each of the plurality of elements (1, 2, 3) is made of a material selected from a group consisting of non-metallic, metallic, organic or inorganic or a combination thereof.

9. System according to claim 1, wherein each of the plurality of elements (1, 2, 3) further includes at least one magnetic component (4, 5) attractable by the platform surface (17) through magnetic forces.

10. System according to claim 9, wherein the magnetic component (4, 5) is polarized.

11. System according to claim 9, wherein the magnetic component forms an extension on the top back surface of the element, thus when attached to the platform, forms a space between the platform and the portion of the element carrying the magnetic components.

12. An element to be secured to a platform surface (17), as defined as in claim 1.

13. System according to claim 1, further comprising a receptacle (6, 9) formed for receiving a conventional pen (21) therein, a magnet (8, 16) is embedded in a portion thereof to secure a portion of the receptacle to the platform (17), wherein the receptacle (6, 9) and the received pen (21) are configured to be inclined in a range of 0° to 90° with respect to the platform (17).

14. The System according to claim 13, wherein the portion of the receptacle (9) which forms contact with the platform is formed in either a curved shape (13) or a flat shape (7) and wherein the receptacle (9) and the received pen (21) are configured to be inclined in a range of 0° to 45° with respect to the platform (17).

15. (canceled)

16. Method of organizing, arranging, communicating, interacting with and/or visualizing information, wherein the system of claim 1 is used.

17. The System of claim 1, wherein a first group of the plurality of elements (1, 2) have a geometric form and carry a piece of information (19) thereupon, and each of a second group of the plurality of elements (3) are smaller in size that at least one of the first group of elements (1, 2) and are adapted to be positioned onto or in proximity to the first group of the plurality of elements (1, 2) thereby weighting and evaluating the piece of information (20) upon the at least one of the first group of the plurality of elements (1, 2).

18. The system of claim 17, wherein the second group of the plurality of elements (3) are adapted to be stacked onto each other and or onto the first group of the plurality elements (1, 2).

19. The system of claim 17, wherein the at least some of the first plurality of elements carrying a piece of information (24, 25, 26) are differently colored.

20. The system of claim 17, wherein the platform surface (17) is rewriteable and adapted for structuring and/or organizing the first plurality of elements and/or the pieces of information thereupon (23).

21. A kit for use in organizing, arranging, communicating, interacting with and/or visualizing information, comprising i) at least one of a plurality of elements (1, 2, 3) configured to be secured to a platform surface (17), characterized in that each of the plurality of elements is repositionable and/or shiftable, and has a modulus of elasticity (E-module) of >0.5 kN/mm² and a material thickness of 0.1 to 30 mm, wherein the platform surface (17) is a magnetic or magnetizable device, and wherein each of the plurality of elements (1, 2, 3) is magnetically securable to the platform surface (17), and ii) a receptacle (6, 9) formed for receiving a conventional pen (21) therein, a magnet (8, 16) is embedded in a portion thereof to secure a portion of the receptacle to the platform (17), wherein the receptacle (6, 9) and the received pen (21) are configured to be inclined in a range of 0° to 90° with respect to the platform (17) and optionally a case for storing the same.
